(19) United States
(12) Patent Application Publication
(10) Pub. No.: US 2011/0064395 A1
(43) Pub. Date: Mar. 17, 2011

(54) Combined Structure of Waterproof Lens and Camera for Monitoring Purpose

(76) Inventors: Sheng Jung CHANG, Taipei (TW); Liang-Chi Lin, Xizhi City (TW)

(21) Appl. No.: 12/558,585

(22) Filed: Sep. 14, 2009

(51) Int. Cl. G03B 17/08

(52) U.S. Cl. 396/25

(57) ABSTRACT

A combined structure of waterproof lens and waterproof camera for rapid and simple assembly and disassembly; it comprising: waterproof lens and waterproof camera; in particular: the locking portions, such as internal thread and groove, are arranged onto the hollow wall of a socket end of the waterproof lens, while snapping portions, such as external thread and retaining clip, are arranged around an embedding end of the waterproof camera; based on this structural design, the waterproof lens and waterproof camera can be combined easily by the matched locking portions and snapping portions, thus realizing rapid separation for subsequent efficient repair, maintenance and replacement.

### BACKGROUND OF INVENTION

1. Field of the Invention

The present invention relates generally to a waterproof lens and a waterproof camera, and more particularly to a combined structure which enables rapid and simple assembly or disassembly of the waterproof lens and camera for monitoring purpose.

2. Description of Related Art

A typical monitor comprises a monitor body and a support with randomly adjustable angle, enabling it to be erected at any position. The monitor body is provided securely with a camera, which is covered by a protective lens for protection and waterproofing purpose.

As the lens of the commonly-used monitor is often embedded into the monitor body, and the protective lens and monitor body are coupled tightly (difficult to be disassembled or separated), the service personnel may find it difficult to repair, maintain and replace it regularly despite of a certain degree of protection and waterproofing function. In such case, this will lead to higher cost in the event of any damage during assembly or disassembly process.

To this end, the inventor has provided the present invention of practicability for the benefit of the people after deliberate design based on his years of experience.

### SUMMARY OF THE INVENTION

The main objective of the present invention is to provide a combined structure of waterproof lens and waterproof camera, which enables simple assembly or disassembly and subsequent repair, maintenance or replacement.

The present invention comprises: a waterproof lens and a waterproof camera; in particular, the locking portions, such as internal thread and groove, are arranged onto the hollow wall of a socket end of the waterproof lens, while snapping portions, such as external thread and retaining clip, are arranged around an embedding end of the waterproof camera; based on this structural design, the waterproof lens and waterproof camera can be combined easily by the matched locking portions and snapping portions, thus realizing rapid separation for subsequent efficient repair, maintenance and replacement.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows a partially exploded view of a preferred embodiment of the camera of the present invention.

FIG. 2 shows an exploded view of a preferred embodiment of the waterproof lens of the present invention.

FIG. 3 shows an exploded view of a preferred embodiment of the waterproof camera of the present invention.

FIG. 4 shows a combined view of a preferred embodiment of the camera of the present invention.

FIG. 5 shows a combined view of another preferred embodiment of the camera of the present invention.

### DETAILED DESCRIPTION OF THE INVENTION

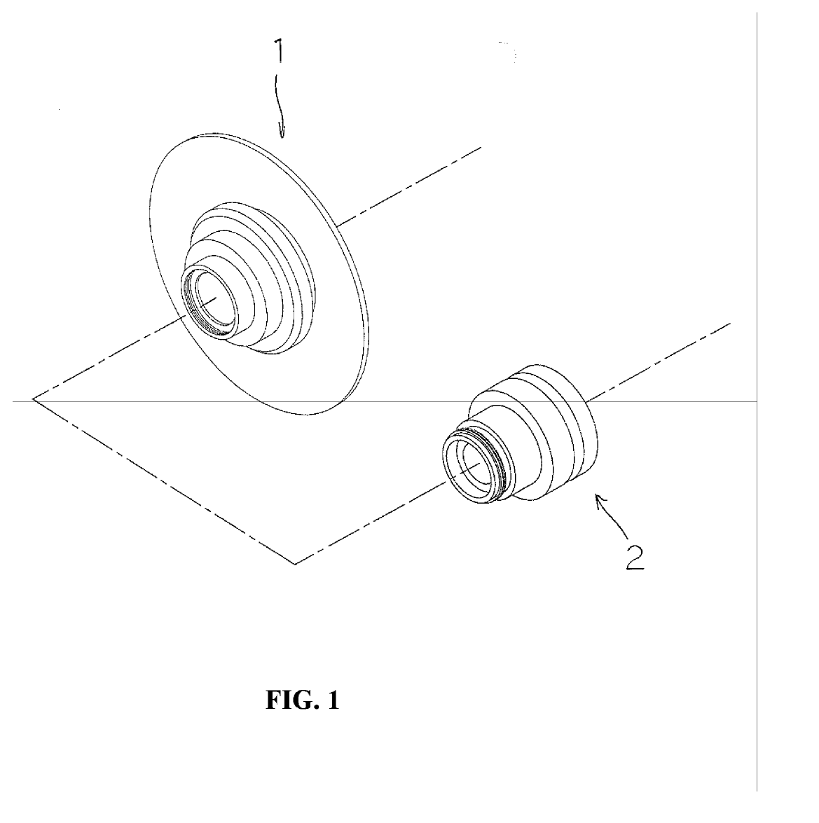

Referring to FIG. 1, the combined structure of the waterproof lens and waterproof camera for monitoring purpose may at least comprise: a waterproof lens 1 and a waterproof camera 2; of which:

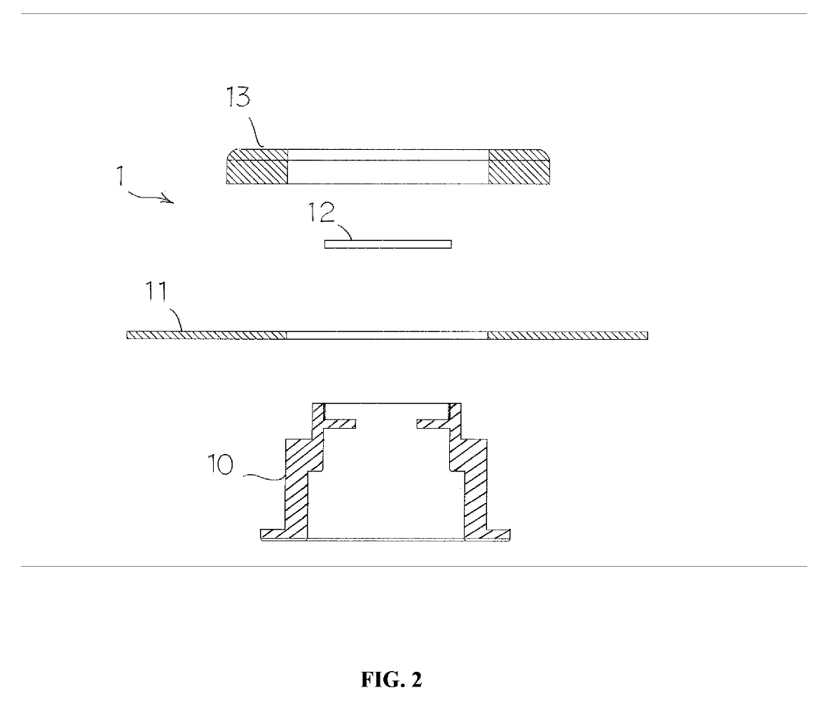

Referring to FIG. 2, the waterproof lens 1 can be flexibly assembled onto or removed from the monitor body; it further comprising: a pedestal 10, glass lens 11, small lens 12 and shield 13; the pedestal 10, with a multi-layer step, is fitted with a reducing through-hole 101 at both ends, of which a socket end 102 is placed at one end; moreover, the locking portion 103 like an internal thread is arranged on the inner wall; the glass lens 11 is made of toughened glass, and a round hole 111 is centrally sleeved onto the pedestal 10; the small lens 12 is laterally embedded onto the boundary of the reducing through-hole 101 within the pedestal 10; the shield 13 is covered at one side of the glass lens 11, permitting to restrict and prevent the glass lens 11 from disengagement or fall from the pedestal 10.

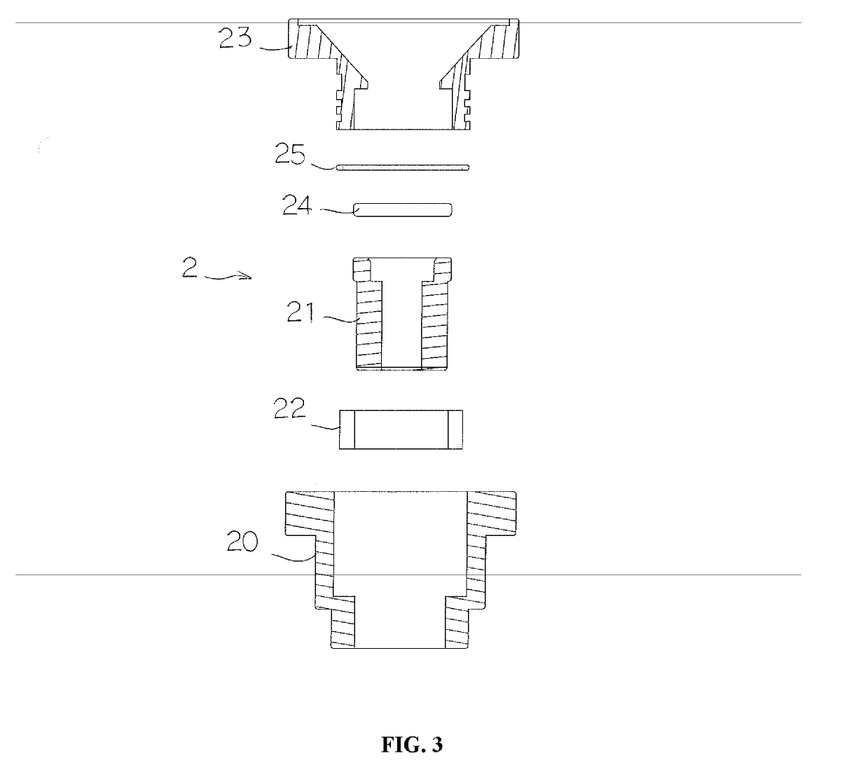

Referring to FIG. 3, the waterproof camera 2 is similarly provided with a barrel-like or multi-layer lens mount 20, and also fitted with a reducing through-hole 201 at both ends; a lens 21 and a locking ring 22 are assembled into the through-hole 201, of which the lens 21 is positioned by the locking ring 22; the lens 21 is connected to a waterproof shield 23 fitted with a lens 24, and a water stop ring 25 is sleeved onto one end for watertight assembly; moreover, an embedding end 202 at one end of the lens mount 20 can be embedded into the socket end 102 corresponding to the pedestal 10 of the waterproof lens 1, and a snapping portion 203 is arranged at the periphery; the snapping portion 203 of external thread shape can be mated smoothly with the locking portion 103, such that the waterproof lens 1 and waterproof camera 2 can be combined together.

Based on the above structural design, a combined structure of waterproof lens and waterproof camera featuring ease-of-assembly/disassembly can be formed.

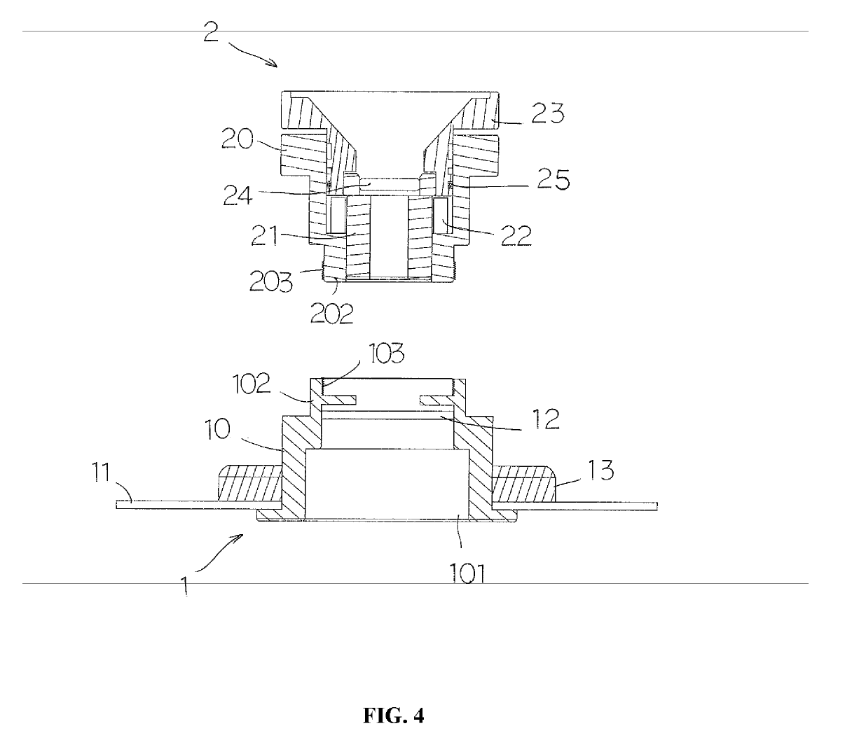

To combine the waterproof lens 1 with the waterproof camera 2, the embedding end 202 of the lens mount 20 of the waterproof camera 2 shall be used in a manner that the snapping portion 203 of external thread shape matches the locking portion 103 of internal thread shape on the inner wall of the socket end 102 onto the pedestal 10 of waterproof lens 1, thereby combining them by means of screwing; as shown in FIG. 4, this method enables to combine easily the waterproof lens 1 and waterproof camera 2; for disassembly, the waterproof lens 1 and waterproof camera 2 can be separated in a reverse sequence for subsequent repair, maintenance and replacement of waterproof camera 2.

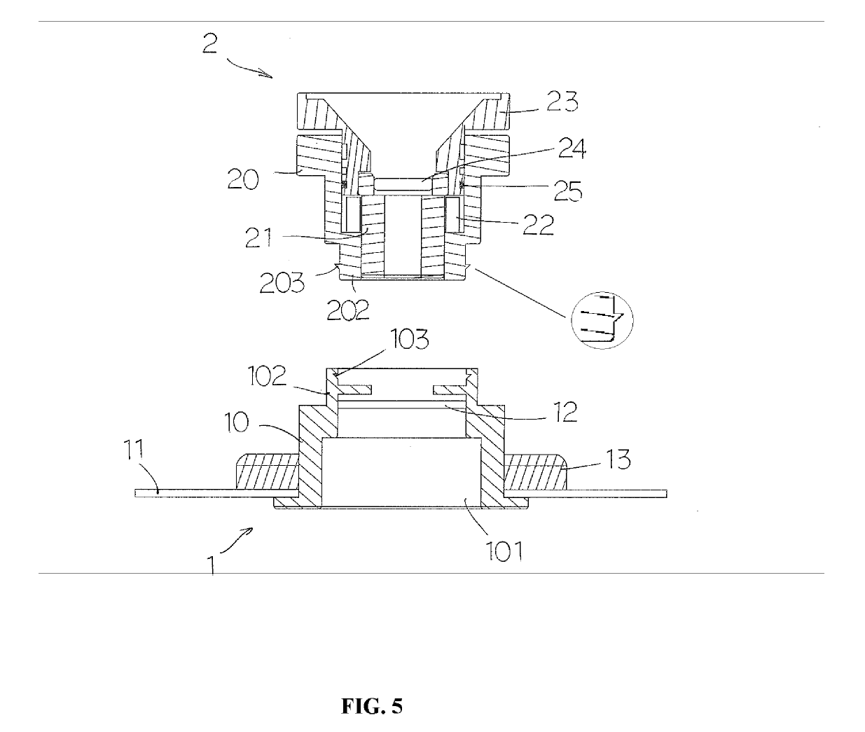

Referring also to FIG. 5, the combined structure of the waterproof lens 1 and waterproof camera 2 is equipped with internal and external threads for simple assembly and disassembly; moreover, the snapping portion 203 and locking portion 103 can be adopted in such a manner that the locking portion 103 of groove is arranged on the inner wall of the socket end 102 of the waterproof lens 1, and the snapping portion 203 of retaining clip arranged around the embedding end 202 of the lens mount 20 of the waterproof camera 2; so the waterproof lens 1 and waterproof camera 2 can be combined or separated quickly through the structural design of the retaining clip and groove.

As the waterproof lens and waterproof camera are assembled easily and quickly with a simple structure (e.g. combination of internal and external threads, or groove and retaining clip), the service personnel may find it very easy for assembly or disassembly, allowing for trouble-free maintenance; furthermore, with the simple combined structure of the waterproof lens and waterproof camera, the service personnel may conduct regular repair, maintenance and replacement without removal of the waterproof lens, thus improving greatly the productivity.

To sum up, the present invention can realize the expected performance in compliance with the requirements of the patent claims.

Although the invention has been explained in relation to its preferred embodiment, it is to be understood that many other possible modifications and variations can be made without departing from the spirit and scope of the invention as hereinafter claimed.

1. A combined structure of waterproof lens and waterproof camera for monitoring purpose, comprising:
a waterproof lens, one end of which is provided with a socket end, and a locking portion is arranged on the inner wall; and
a waterproof camera, one end of which camera is provided with an embedding end for fitting into the socket end corresponding of the pedestal of the waterproof lens, and a snapping portion is arranged at the periphery;
with the combination of locking portion and snapping portion, the waterproof lens and waterproof camera can be combined or separated quickly.

2. The combined structure of waterproof lens and waterproof camera for monitoring purpose as claimed in claim 1, wherein the locking portion is of internal thread, and the snapping portion of external thread.

3. The combined structure of waterproof lens and waterproof camera for monitoring purpose as claimed in claim 1, wherein the locking portion is of groove, and the snapping portion of retaining clip.

4. The combined structure of waterproof lens and waterproof camera for monitoring purpose as claimed in claim 1, wherein the waterproof camera is rotatable about a rotational axis and is easily assembled onto or removed from the monitor body; it further comprising: a pedestal, glass lens, small lens and shield.

5. The combined structure of waterproof lens and waterproof camera for monitoring purpose as claimed in claim 1, wherein the waterproof camera further comprises a lens mount fitted with a lens and a locking ring.
